(19) United States
(12) Patent Application Publication
(10) Pub. No.: US 2007/0086394 A1
(43) Pub. Date: Apr. 19, 2007

(54) Wireless communication terminal and connection information setting method

(76) Inventors: Tomohiro Yamada, Hyogo (JP); Motoe Sakanaka, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/578,251

(22) PCT Filed: Oct. 7, 2004
(86) PCT No.: PCT/JP04/15209

§ 371 Date: May 4, 2006

(30) Foreign Application Priority Data
Nov. 6, 2003 (JP) 2003-376584

(51) Int. Cl. H04Q 7/24

(52) U.S. Cl. 370/338

(57) ABSTRACT

A PC (10) has an SSID and a WEP key required for wireless communication with a wireless LAN access point router (30). When the PC (10) has wireless connection with the Internet radio receiver (20) in Ad-Hoc mode, the PC (10) transfers the encrypted SSID and WEP key to the Internet radio receiver (20). The Internet radio receiver (20) decrypts the transferred SSID and WEP key and validates the decrypted SSID and WEP key.

### TECHNICAL FIELD

The present invention relates to a wireless communication terminal and a connection information setting method. More specifically, the present invention relates to a wireless communication terminal and a connection information setting method by which connection information is set to a wireless communication terminal for making a wireless connection to an access point of a network through use of connection information stored in a memory.

### PRIOR ART

A method for setting connection information required for making a wireless connection to an access point of a wireless LAN (Local Area Network) to a PC (Personal Computer) through use of a keyboard and mouse is minutely disclosed in a guidebook “Introduction to Settings with Wireless LAN and High-speed Internet, Shunichi Murakami, MEDIA TECH Publishing, Inc., May, 2003”.

By this method, however, it is impossible to set connection information to such devices as portable music players and Internet radio receivers with limitations on the display size and the number of operating keys.

### SUMMARY OF THE INVENTION

Therefore, it is a primary object of the present invention to provide a novel wireless communication terminal and connection information setting method.

It is another object of the present invention to provide a wireless communication terminal and a connection information setting method that make it easy to set connection information to a wireless communication terminal with no character input interface.

According to claim 1, a wireless communication terminal for setting connection information required for wireless connection to an access point of a network to a specific wireless communication terminal comprises: an acceptance means for accepting a terminal identifier for identifying the specific wireless communication terminal; a connection means for connecting to the specific wireless communication terminal based on the terminal identifier accepted by the acceptance means; and a transfer means for transferring the connection information to the specific wireless communication terminal after connection by the connection means.

When the terminal identifier for identifying the specific wireless communication terminal is accepted by the acceptance means, the connection means connects with the specific wireless communication terminal based on the terminal identifier. This makes it easy to set the connection information required for wireless connection to the access point of the network to a specific wireless communication terminal with no text input interface.

According to claim 2 that depends on claim 1, the specific wireless communication terminal has an electronic certificate of authentication from an authentication terminal connected to the network, and the wireless communication terminal further comprises: an acquisition means for acquiring the electronic certificate from the specific wireless communication terminal after the connection by the connection means; and a determination means for determining whether the specific wireless communication terminal is an authorized terminal or not based on the electronic certificate acquired by the acquisition means, and the transfer means transfers the connection information when result of determination by the determination means is affirmative.

The specific wireless communication terminal acquires the electronic certificate of authentication by the authentication terminal. The acquisition means acquires the electronic certificate from the specific communication terminal, and the determination means determines whether the specific wireless communication terminal is an authorized terminal or not based on the electronic certificate acquired by the acquisition means. When the result of determination by the determination means is affirmative, that is, when the specific wireless terminal is an authorized terminal, the transfer means transfers the connection information to the specific wireless communication terminal. Therefore, it is possible to prevent an unauthorized wireless communication terminal from acquiring the connection information.

According to claim 3 that depends on claim 2, the electronic certificate contains an address of the authentication terminal, and the determination means includes an access means for accessing the authentication terminal according to the address and a request means for requesting the authentication terminal to authenticate the specific wireless communication terminal.

Accordingly, the wireless communication terminal is not required to acquire the address of the authentication terminal separately.

According to claim 4 that depends on claim 1, the connection information includes an access point identifier for identifying the access point. This makes it possible to provide the access point identification information to the specific wireless communication terminal with no text input interface.

According to claim 5, the connection information includes encryption key information for carrying out encrypted communication with the address point. This makes it possible to provide the encryption key to the specific wireless communication terminal with no text input interface.

According to claim 6, a connection information setting method for setting connection information required for wireless connection to an access point of a network to a specific wireless communication terminal comprises the following steps of: (a) accepting a terminal identifier for identifying the specific wireless communication terminal; (b) connecting with the specific wireless communication terminal based on the terminal identifier accepted in the step (a); and (c) transferring the connection information to the specific wireless communication terminal.

As with the above described claim 1, this makes it easy to set the connection information to the specific wireless communication terminal with no text input interface.

According to claim 7, a connection information setting program executed by a processor of a wireless communication terminal for setting connection information required for wireless connection to an access point of a network to a specific wireless communication terminal comprises: an acceptance step of accepting a terminal identifier for identifying the specific wireless communication terminal; a connection step of connecting with the specific wireless communication terminal based on the terminal identifier accepted in the acceptance step; and a transfer step of transferring the connection information to the specific wireless communication terminal after the connection in the connection step.

As with the above described claim 1, this makes it easy to set the connection information to the specific wireless communication terminal with no text input interface.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2 is a block diagram showing one example of configuration of a personal computer applied to FIG. 1 embodiment;

FIG. 3 is a block diagram showing one example of configuration of an Internet radio receiver applied to FIG. 1 embodiment;

FIG. 4 is a flowchart showing a part of operation of a CPU applied to FIG. 2 embodiment and a part of operation of an MCU applied to FIG. 3 embodiment; and

FIG. 5 is a flowchart showing another part of operation of the CPU applied to FIG. 2 embodiment and another part of operation of the MCU applied to FIG. 3 embodiment.

### BEST MODE FOR PRACTICING THE INVENTION

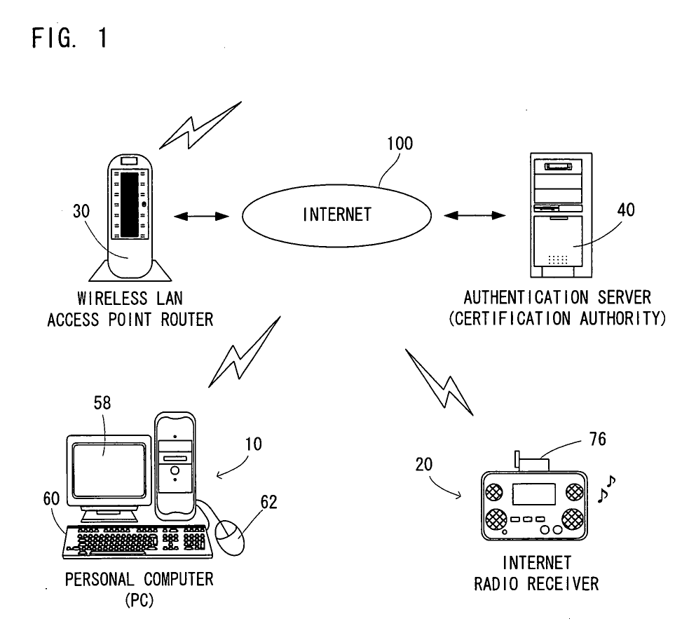

Referring to FIG. 1, a PC 10 of this embodiment can be connected to a wireless LAN access point router 30 by wireless communication. The PC 10 is used to make settings for wireless communication between the Internet radio receiver 20 and the wireless LAN access point router 30.

The wireless LAN access point router 30 is connected to the Internet 100. An authentication server 40 for authenticating the Internet radio receiver 20 exists on the Internet 100. Besides, the wireless LAN access point router 30 has a DHCP (Dynamic Host Configuration Protocol) function of assigning network information such as IP addresses to wireless communication terminals connected to a network.

An electronic certificate issued by the authentication server 40 and a secret key corresponding to a public key contained in the electronic certificate are written into a storage unit of the Internet radio receiver 20 in a manufacturing stage. Additionally, the electronic certificate contains an address (URL: Uniform Resource Locator) of the authentication server 40 on the Internet 100 as well as the public key.

The Internet radio receiver 20 connects to the Internet 100 via the wireless LAN access point router 30, and receives a streaming distribution of audio contents such as music from a radio station (not shown) existing on the Internet 100.

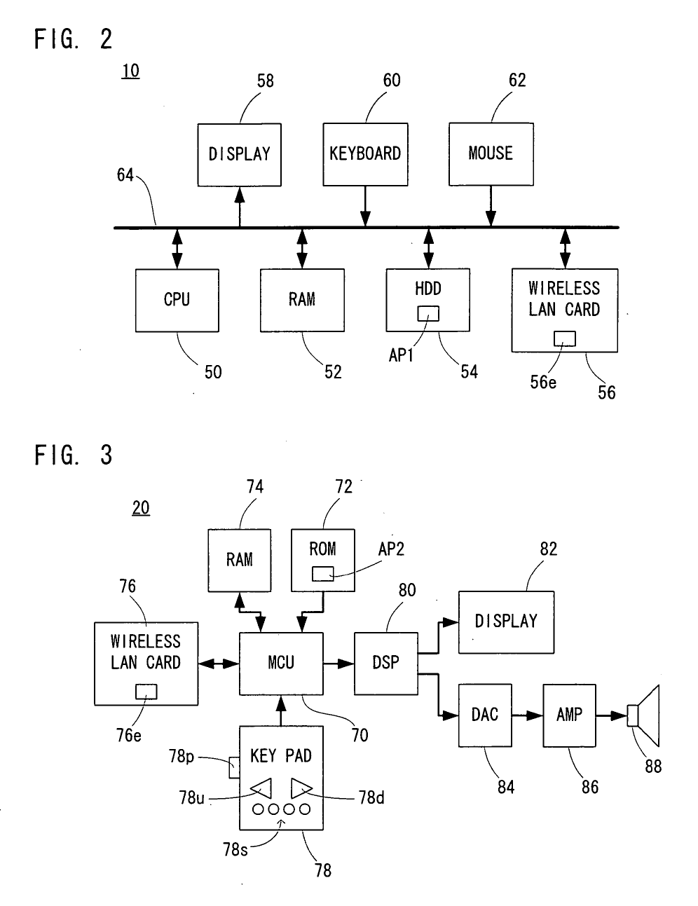

More specifically, the PC 10 is configured as shown in FIG. 2. According to FIG. 2, the PC 10 includes a CPU (Central Processing Unit) 50. The CPU 50 is connected via a bus 64 with a RAM (Random Access Memory) 52, an HDD (Hard Disc Drive) 54, a wireless LAN card 56, a display 58, a keyboard 60 and a mouse 62. The wireless LAN card 56 has an EEPROM (Electronically Erasable PROM) 56e. The CPU 50 executes a process according to a program recorded in the HDD 54. Besides, the HDD 54 stores an application program API for making settings for connecting the Internet radio receiver 20 to the wireless LAN access point router 30.

Also, the Internet radio receiver 20 is more specifically configured as shown in FIG. 3. According to FIG. 3, the Internet radio receiver 20 includes an MCU (Micro Controller Unit) 70. The MCU 70 is connected to a ROM (Read Only Memory) 72, a RAM 74, a wireless LAN card 76, a key pad 78 and a DSP (Digital Signal Processor) 80. The display 82 is connected directly with the DSP 80. In addition, the speaker 88 is connected with the DSP 80 via an AMP (AMPlifier) 86 and a DAC (Digital to Analog Converter) 84. The wireless LAN card 76 is provided with an EEPROM 76e.

The key pad 78 comprises a power key 78p, an up key 78u and a down key 78d for selecting a radio station, and a plurality of preset keys 78s for selecting a specific stored radio station. Besides, no input interface for easy text input such as a keyboard is prepared in the Internet radio receiver 20. The MCU 70 executes a process according to a program stored in the ROM 72. Additionally, the ROM 72 stores an application program AP2 for accepting settings for connecting the Internet radio receiver 20 to the wireless LAN access point router 30. Moreover, the above mentioned electronic certificate and a secret key are stored in the ROM 72.

By setting an SSID (Service Set IDentifier) and a WEP (Wired Equivalent Privacy) keys as connection information to the wireless LAN card 76, the Internet radio receiver 20 is allowed to carry out wireless communications with the wireless LAN access point router 30.

In this embodiment, the standards called IEEE802. 11 are employed for implementation of such wireless communications. The standards are specified by a section committee of IEEE (Institute of Electrical and Electronics Engineers Inc.) related to wireless LAN system standardization.

In wireless LAN communications using IEEE802. 11, an access point identifier called SSID is assigned to a wireless communication terminal. Wireless communications in an infrastructure mode are available only between wireless communication terminals having same SSID. Thus, in order to carry out wireless communications in the infrastructure mode among the PC 10, the Internet radio receiver 20 and the wireless access point router 30, it is necessary to set the same SSID to the PC 10, the Internet radio receiver 20 and the wireless access point router 30.

Besides, the infrastructure mode is a mode in which wireless communication terminals are connected to each other via an access point such as the wireless access point router 30. For reference's sake, a mode for direct connection between wireless communication terminals not via an access point is called Ad-Hoc mode. In the Ad-Hoc mode, it is necessary to set an SSID that is common only among desired wireless communication terminals.

In addition, a security algorithm called WEP is used for wireless LAN communications in conformity with IEEE802. 11. According to the WEP algorithm, each of wireless communication terminals in communication with each other holds a WEP key (encryption key), and wireless communications can be carried out only if there is a match of the WEP key between the terminals. More specifically, data transmitted from a wireless communication terminal is encrypted by the WEP key, and the encrypted data is decrypted by the same WEP key as used for the encryption in a wireless communication terminal receiving the data. Therefore, the common WEP key is used for wireless communications among the PC 10, the Internet radio receiver 20 and the wireless access point router 30.

In using a wireless communication terminal firstly after purchase or in using a wireless communication terminal in a wireless LAN environment that is different from that of the past, it is required to set to the wireless communication terminal an SSID and a WEP key inherent in the wireless LAN environment to be employed. It is easy to set an SSID and WEP key to a wireless communication terminal to be newly connected to the wireless LAN if the terminal has a good text input interface such as the keyboard 60 shown in FIG. 1.

However, if a wireless communication terminal to be newly connected to the wireless LAN does not have a text input interface, as in the case with the Internet radio receiver 20, it is difficult to set an SSID and WEP key.

Thus, in this embodiment, the PC 10 and the Internet radio receiver 20 are wirelessly connected to each other in the Ad-Hoc mode, and the PC 10 sets an SSID and a WEP key to the wireless LAN card 76 of the Internet radio receiver 20.

More specifically, a default SSID of the Internet radio receiver 20 is set to the PC 10. Also, an IP address having a network part which coincides with that of a default static IP (Internet Protocol) address of the Internet radio receiver 20 are set to the PC 10. Besides, the default SSID and static IP address can be known from an instruction manual for the Internet radio receiver 20. This allows a wireless connection in the Ad-Hoc mode to be established between the PC 10 and the Internet radio receiver 20.

When the wireless connection is established, the PC 10 acquires an electronic certificate from the Internet radio receiver 20 and inquires the authentication server 40 about whether a public key contained in the acquired electronic certificate is registered or not. This makes it possible to make sure the Internet radio receiver 20 is an authorized device and prevent an unauthorized acquisition of a WEP key etc.

When authentication of the Internet radio receiver 20 is successfully performed, the PC 10 encrypts its own SSID and WEP key used for wireless communications with the wireless LAN access point router 30 through use of the public key extracted from the electronic certificate. The encrypted SSID and WEP key are transmitted to the Internet radio receiver 20. Upon completion of the transmission, the PC 10 recovers to the infrastructure mode.

The Internet radio receiver 20 decrypts the encrypted SSID and WEP key transmitted from the PC 10 by use of a secret key corresponding to the public key transmitted to the PC 10. The decrypted WEP key and SSID are set to the wireless LAN card 76. Upon completion of the setting, the Internet radio receiver 20 changes the communication mode to the infrastructure mode.

As mentioned above, when the new SSID and WEP key are set to the wireless LAN card 76 of the Internet radio receiver 20, it becomes possible to carry out wireless communications with the wireless LAN access point router 30.

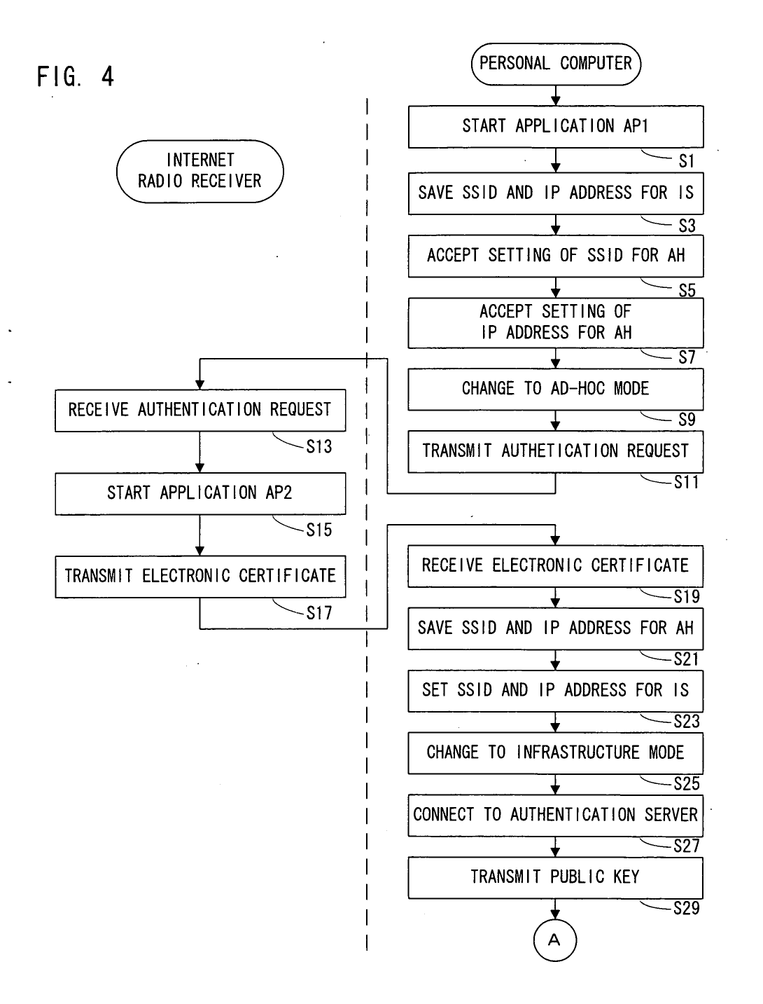

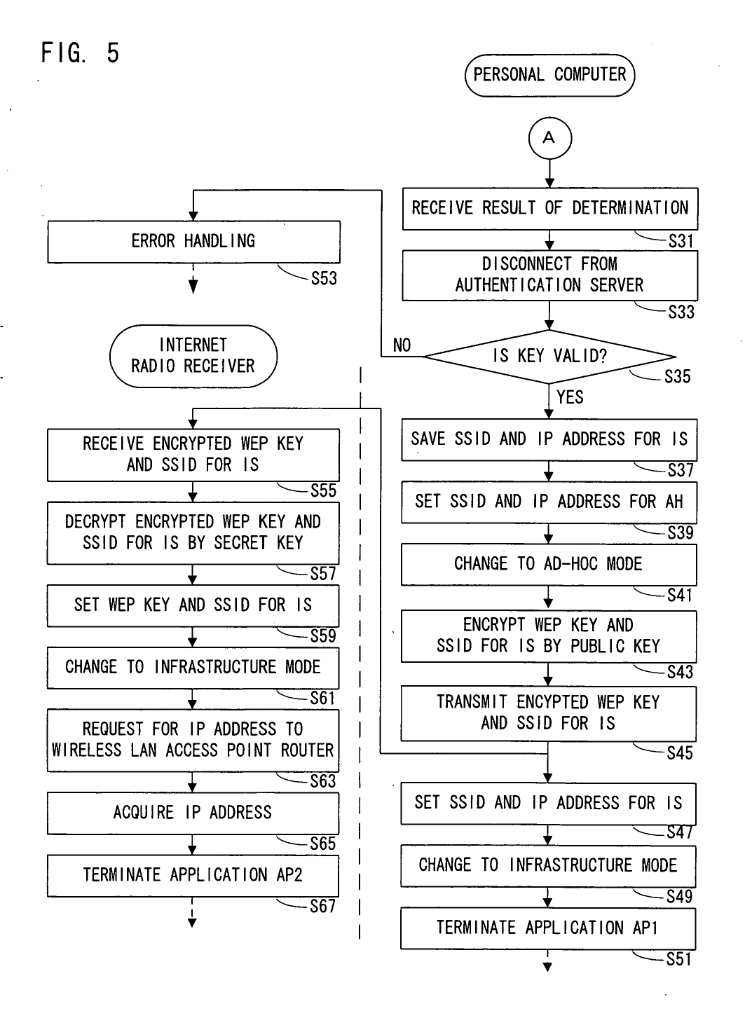

In setting an SSID and a WEP key to the Internet radio receiver 20, the CPU 50 of the PC 10 and the MCU 70 of the Internet radio receiver 20 execute processes according to flowcharts shown in FIG. 4 and FIG. 5.

Firstly, a user uses a CD-ROM included with the Internet radio receiver 20 to install on the PC 10 the application program API for setting an SSID and a WEP key to the Internet radio receiver 20. Then, the user uses the mouse 62 to double-click on an icon for starting the application program AP1 that is displayed on the display 58.

Accordingly, the CPU 50 of the PC 10 starts the application program AP 1 in a step S1. In a step S3, the SSID and IP address for infrastructure mode (IS mode) currently set in the wireless LAN card 56 of the PC 10 are saved in the RAM 52.

The user inputs the SSID and static IP address for Ad-Hoc mode (AH mode) according to a guide in a web page displayed on the display 58 of the PC 10. The SSID and static IP address to be input are the SSID and static IP address set as defaults in the wireless LAN card 76 of the Internet radio receiver 20, and can be known from the instruction manual for the Internet radio receiver 20.

The input SSID and static IP address are accepted in steps S5 and S7, respectively. The SSID is written as it is into the EEPROM 56e of the wireless LAN card 56. Meanwhile, the static IP address is subjected to a conversion into an IP address matching with the static IP address only in a network part, and then the converted IP address is written into the EEPROM 56e.

When the setting of the SSID and IP address for AH mode is completed, the PC 10 changes from the infrastructure mode to the Ad-Hoc mode in a step S9, and transmits a request for authentication to the Internet radio receiver 20 on the other end of communication in the Ad-Hoc mode in a step S11.

The MCU 70 of the Internet radio receiver 20 receives the authentication request in a step S13, and starts the setup application program AP2 in a step S15. In a step S17, an electronic certificate is read from the ROM 72, and the read electronic certificate is transmitted to the PC 10.

The PC 10 receives the electronic certificate transmitted from the Internet radio receiver 20 in a step S19. In a step S21, the SSID and IP address for AH mode currently set in the wireless LAN card 56 are saved in the RAM 52, and the SSID and IP address for IS mode saved in the RAM 52 in the earlier step S3 are set to the wireless LAN card 56.

The communication mode is changed to the infrastructure mode in a step S25, and the authentication server 40 is accessed via the wireless LAN access point router 30 in a step S27. As stated above, the URL for access to the authentication server 40 is contained in the electronic certificate received from the Internet radio receiver 20.

In a step S29, the public key extracted from the electronic certificate is transmitted to the authentication server 40 for determination on validity of the public key. In a step S3 I of FIG. 5, a result of determination on validity of the public key is received from the authentication server 40. Upon completion of the reception, the connection with the authentication server 40 is terminated in a step S33.

In a step S35, it is determined whether the result of determination on validity of the public key is affirmative or not, that is, whether the public key is valid or not. If NO in the step S35, error handling is carried out in a step S53. On the other hand, if YES in the step S35, the process proceeds to a step S37 and later. By verifying the validity of the public key, it is possible to authenticate the Internet radio receiver 20 as an authorized device.

In the step S37, the SSID and IP address for IS mode set in the wireless LAN card 56 are saved in the RAM 52. In a step S39, the SSID and IP address for AH mode saved in the RAM 52 are set to the wireless LAN card 56. In a step S41, the communication mode is changed to the Ad-Hoc mode.

In a step S43, the WEP key recorded in the EEPROM 56e of the wireless LAN card 56 and the SSID for IS mode saved in the RAM 52 are encrypted by use of the public key verified for validity. In a step S45, the encrypted WEP key and SSID for IS mode are transmitted to the Internet radio receiver 20.

When the transmission of the encrypted WEP key and SSID for IS mode is completed, the process moves to a step S47 to set the SSID and IP address for IS mode saved in the RAM 52 to the wireless LAN card 56. The communication mode is changed to the infrastructure mode in a step S49, and the application program AP I is terminated in a step S51.

Meanwhile, the Internet radio receiver 20 receives the encrypted WEP key and SSID for IS mode transmitted from the PC 10, in a step S55. In a step S57, the secret key is read from the ROM 72, and then the received WEP key and SSID for IS mode are decrypted by use of the read secret key. The decrypted WEP key and SSID for IS mode are set to the EEPROM 76e of the wireless LAN card 76 in a step S59. In a step S61, the communication mode is changed to the infrastructure mode.

A request for IP address is made to the wireless LAN access point router 30 in a step S63, and the IP address is acquired from the wireless LAN access point router 30 in a step S65. The acquired IP address is set to the wireless LAN card 76. Upon completion of the setting, the application program AP2 is terminated in a step S67.

Thus, as a result of setting the WEP key and SSID to the Internet radio receiver 20, the Internet radio receiver 20 is allowed to connect to the PC 10 and the Internet 100 via the wireless LAN access point router 30.

As understood from the above description, the connection information required for wireless connection with the wireless LAN access point router 30 (SSID, WEP key, etc.) are input to the PC 10 by means of the keyboard 60 or the mouse 62. The input connection information is set by the PC 10 to the Internet radio receiver 20. Consequently, it is easy to set the connection information required for wireless connection to a wireless communication terminal with no text input interface.

Besides, in this embodiment, the Internet radio receiver 20 is assumed as a device for making a setting of wireless communication connection. However, such a device is not limited to Internet radio receiver as far as it is a wireless communication terminal that carries out wireless communications with setting of connection information such as a WEP key and an SSID. Alternatively, the process operations of the PC 10 shown in FIG. 4 and FIG. 5 may be assigned to the wireless LAN access point router 30.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A wireless communication terminal for setting connection information required for wireless connection to an access point of a network to a specific wireless communication terminal, comprising:
an acceptance means for accepting a terminal identifier for identifying said specific wireless communication terminal;
a connection means for connecting to said specific wireless communication terminal based on the terminal identifier accepted by said acceptance means; and
a transfer means for transferring said connection information to said specific wireless communication terminal after connection by said connection means.

2. A wireless connection terminal according to claim 1, wherein said specific wireless communication terminal has an electronic certificate of authentication by an authentication terminal connected to said network, and wherein
said wireless communication terminal further comprises: an acquisition means for acquiring said electronic certificate from said specific wireless communication terminal after the connection by said connection means; and a determination means for determining whether said specific wireless communication terminal is an authorized terminal or not based on said electronic certificate acquired by said acquisition means, and
said transfer means transfers said connection information when result of determination by said determination means is affirmative.

3. A wireless connection terminal according to claim 2, wherein said electronic certificate contains an address of said authentication terminal, and said determination means includes an access means for accessing said authentication terminal according to said address and a request means for requesting said authentication terminal to authenticate said specific wireless communication terminal.

4. A wireless connection terminal according to claim 1, wherein said connection information includes an access point identifier for identifying said access point.

5. A wireless connection terminal according to claim 1, wherein said connection information includes encryption key information for carrying out encrypted communication with said address point.

6. A connection information setting method for setting connection information required for wireless connection to an access point of a network to a specific wireless communication terminal, comprising following steps of:
(a) accepting a terminal identifier for identifying said specific wireless communication terminal;
(b) connecting with said specific wireless communication terminal based on the terminal identifier accepted in said step (a); and
(c) transferring said connection information to said specific wireless communication terminal.

7. A connection information setting program executed by a processor of a wireless communication terminal for setting connection information required for wireless connection to an access point of a network to a specific wireless communication terminal, comprising:
an acceptance step of accepting a terminal identifier for identifying said specific wireless communication terminal;
a connection step of connecting with said specific wireless communication terminal based on the terminal identifier accepted in said acceptance step; and
a transfer step of transferring said connection information to said specific wireless communication terminal after the connection in said connection step.
